(19) United States
(12) Patent Application Publication
(10) Pub. No.: US 2004/0215395 A1
(43) Pub. Date: Oct. 28, 2004

(54) Device for automatic measurement of drilling depth on hand power tools, as well as hand power tool for drilling, and method of drilling with drilling depth measurements

(76) Inventors: Andreas Strasser, Rudersberg (DE); Markus Leupert, Murrhardt (DE)

Correspondence Address: STRIKER, STRIKER & STENBY, 103 East Neck Road, Huntington, NY, 11743, US

(21) Appl. No.: 10/824,572

(22) Filed: Apr. 14, 2004

(30) Foreign Application Priority Data
Apr. 25, 2003 (DE) 103 18 799.5

(51) Int. Cl. G01V 1/40

(52) U.S. Cl. 702/9

(57) ABSTRACT

A device for determining a reaching of a preset drill hole depth in a drill hole which is drilled by a drilling tool of a drilling apparatus from a workpiece surface in a workpiece, has a measuring unit which is mountable on and dismountable from the drilling apparatus for contactless measurement of an initial distance when a tip of the drilling tool abuts against the workpiece surface, and a unit for computing an instantaneous distance to the workpiece surface as well as computing by a computing and comparing circuit a drilling progress from the measured initial distance and a measured instantaneous distance, and comparing the drilling progress with a preset drill hole depth; a drilling apparatus and a method of drilling use the device.

### BACKGROUND OF THE INVENTION

The present invention relates to a device for determination of reaching of a preset hole depth in a drill hole drilled with a drilling tool of a drilling device from a workpiece surface in a workpiece.

The present invention also relates to a drilling apparatus provided with such a device, in particular an electrical drilling hand drill, such as a power drill, an impact power drill or a hammer drill.

Moreover, the present invention relates also to a method of drilling, in which reaching a drill hole drilled in a workpiece with a drilling tool of a drilling device from a workpiece surface is determined.

A device of the above mentioned general type, with which the reaching of a preset drill hole depth can be determined in a mechanical way is known from the field of hand drills. The known device includes a depth abutment formed as a longitudinally extending rod displaceable in a guiding opening parallel to a drilling tool longitudinal axis in an additional handle mounted on the drilling apparatus. For adjustment of a desired drill hole depth, the depth abutment is arrested by a clamping mechanism in the guiding opening so that its front end is offset rearwardly relative to the front end of the used drilling tool by the desired drill hole depth. When the front end of the abutment during drilling abuts against the surface of the drilled body, this indicates that the desired drill hole depth is reached.

During drilling of drill holes in workpieces with sensitive surfaces, such mechanical depth abutments can lead however to a damage of the surface, when its front end abuts against the surface at reaching the desired drill hole depth. Moreover, the depth abutments in case of the use of drilling tools with great lengths, are not always sufficiently long and in addition are provided at the left side of the drilling apparatus, so that its front end is sufficiently visible at approaching the preset drill hole depth for right-handed person, but not for a left-handed person since his view is blocked by the drill chuck of the drilling apparatus.

Devices for contactless distance measurements with the use of ultrasound or laser beam are also known. For example such devices are disclosed in German patent document DE 199 24 755 A1 and DE 198 55 296 C1 of the applicant and used for example, among others, for distance measurements for motor vehicles, for example as parking aids.

### SUMMARY OF THE INVENTION

Accordingly, it is an object of the present invention to provide a device for automatic drilling depth measurements in hand power tools, which is a further improvement of the existing devices.

It is also an object of the present invention to provide a drilling apparatus with the inventive device, as well as a method of drilling with the use of the inventive device.

In particular, it is an object of the present invention to provide such a solution, with which the reaching of the preset drill hole depth can be determined in an optical way and thereby contactless and without damaging of sensitive surfaces.

Since contactless distance measurement for example with ultrasound or laser beam, can be performed at great distances, therefore the invention in the case of great drilling apparatuses with great drilling tool diameters or long drilling tools can be used without problem.

The calculated difference between a measured initial distance and the instantaneous distance can be shown on a display or the like, and therefore the user also can be provided with identification of the instantaneous drill hole depth. Thereby for example in a simple manner, the thickness of a plaster layer applied on a brick wall or a limestone wall can be measured by drilling a small drill hole in the plaster layer and reading the drill hole depth until the drilling resistance increases.

In accordance with a preferable embodiment of the present invention it is proposed that the measuring device for contactless distance measurement includes an emitter or transmitter and a receiver of wave signals, for example ultrasound signals or laser signals, as well as an evaluating device for evaluation of the wave signals which are emitted by the emitter to the workpiece surface and reflected back to the receiver. Preferably, the device also includes a storage (memory), in which the initial distance can be stored, which before the beginning of the drilling is measured between the emitter or the receiver of the wave signals and the workpiece surface, when the tip of the drilling tool abuts against the workpiece surface. The intermediately stored value can be inquired in short time intervals by a comparison circuit from the storage, to form the difference with the directly measured instantaneous distance, and to compare this difference or in other words the drilling progress, with the preset drill hole depth.

For presetting of a desired borehole depth, the device is provided preferably with an input device in form of a keyboard or a setting wheel. The input device preferably is completed with an indicating device for indicating the input values. The indicating device can be used simultaneously for indicating the drilling progress or the difference with preset drill hole depth during the drilling. It is advantageously arranged on the drilling apparatus so that during the drilling it can be easily read by the user. Alternatively, it is however also possible to indicate the reached drill hole depth or difference with a preset drill hole depth by means of a row of light diodes. The light diodes, in the course of the drilling process are lit one after the other in correspondence with the drilling progress, and at reaching of the preset drill hole depth can be additionally transferred into a blinking mode.

When desired, the difference determined from the comparison circuit can be used also for controlling the drilling apparatus. For example, a switch controlled by an output variable of the comparison circuit can interrupt the current circuit of a drive motor of the drilling apparatus at reaching the preset drill hole depth.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a side view of a power drill of a device for measuring a drill hole depth and for determining a reaching of a preset drill hole depth;

FIG. 2 is a plan view of the power drill of FIG. 1 at the beginning of a drilling process;

FIG. 3 is a plan view of the power drill of FIG. 1 but during the drilling shortly before reaching a preset drill hole depth;

FIG. 4 is a partially broken and partially cut view taken along the line III-III in FIG. 2; and

FIG. 5 is a view showing a block diagram for illustrating the construction and operation of the device in accordance with the present invention.

### DESCRIPTION OF THE PREFERRED EMBODIMENTS

A power drill 2 shown in the drawings substantially includes a housing 4 with a handle 6, and a drill chuck 8 extending outwardly beyond the housing 4 for clamping a drill 10 or another drilling tool. The power drill 2 also has a device 12 which is arranged removably on the upper side of the housing 4 for contactless measurement of a drill hole depth and determination of a reaching of a preset drill hole depth T in a drill hole 18 which is drilled in a wall 16 or another workpiece by the power drill 2 and the drill 10 in its plane surface 14.

In many commercial power drills the housing 4 on the handle 6 is provided with an on/off switch 20, an adjusting wheel 22 integrated in the on/off switch 20 for adjusting the rotary speed of the drill chuck 8, a locking button 24 for the continuous operation of the power drill 2, and a switch 26 for switching the rotary direction of the drill chuck 8. The housing 4 accommodates an electric motor and a transmission (not shown). It is provided on its side surfaces and on its upper side with ventilation slots 28 or 30 for ventilation of the motor.

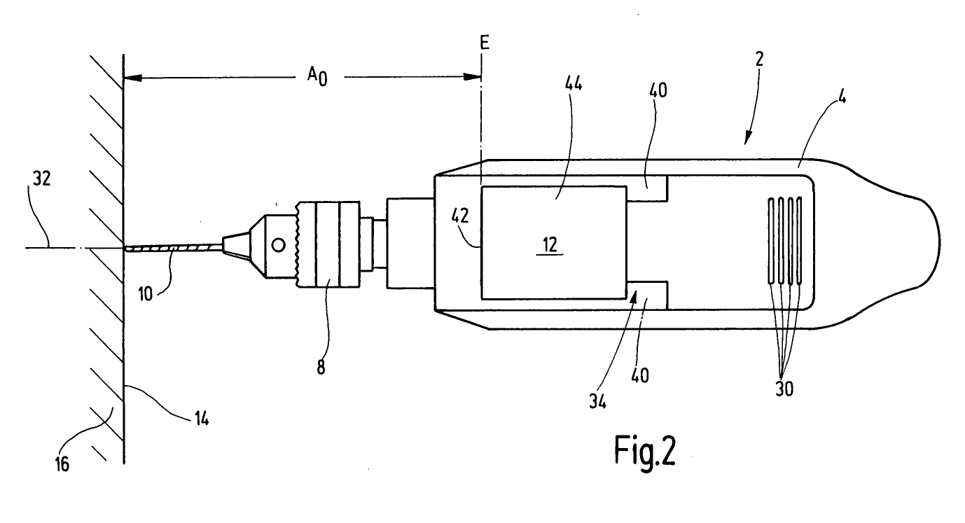

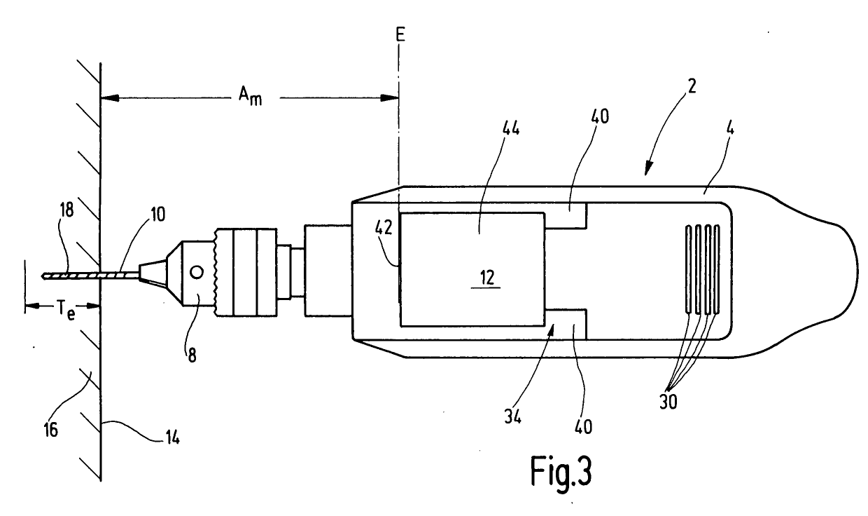

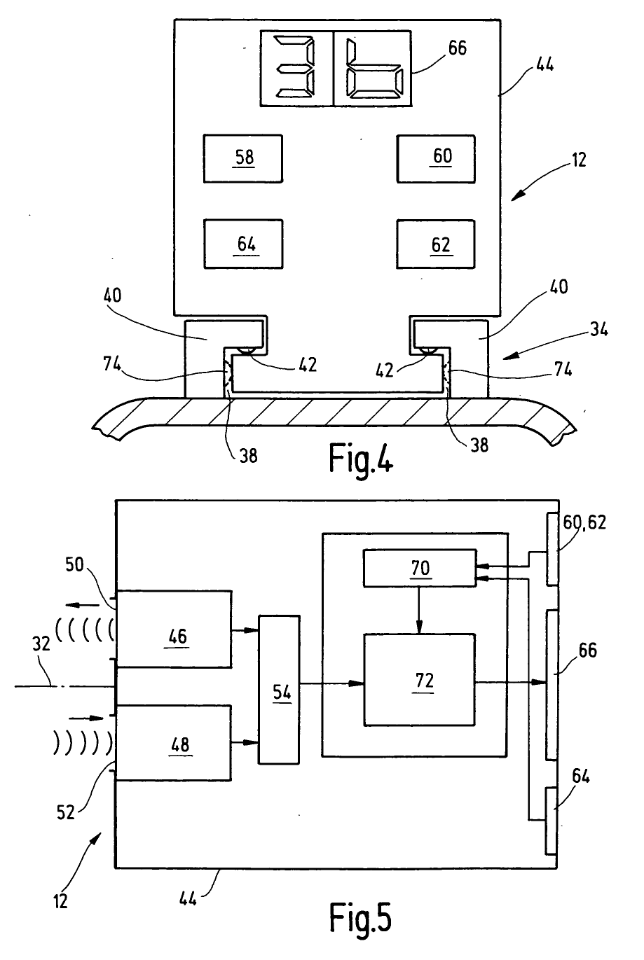

As can be seen from FIGS. 2 and 3, the housing 4, in contrast to conventional power drills, is provided on its upper side with a guide 34 which extends in direction of a drilling axis 32 and is open on the side of the handle 6. The guide 34 is provided for guiding of the device 12 which is insertable in the guide and can be formed as an accessory. The guide 34 is composed substantially of two parallel guiding strips 40 provided on their lower side with undercuts 38 and connected by an abutment 42 at the end facing the drill chuck.

The device 12 is composed substantially of a synthetic plastic housing 44 which is displaceable along the guide 34 and arrestable by not shown arresting means to abut against the abutment. An ultrasound emitter 46 and an ultrasound receiver 48 are arranged in the housing 44, in the front end side close to the workpiece surface 14, as shown in FIG. 2. The ultrasound emitter 46 and the ultrasound receiver 48 are arranged near one another in a plane which is perpendicular to the drilling axis 32 and oriented symmetrically to the drilling axis 32 in direction of the workpiece surface 14.

The ultrasound emitter 46 emits ultrasound waves in a pulse-echo process through a house opening 50 in direction of the workpiece surface 14. The ultrasound receiver 48 receives, through a housing opening 52, the ultrasound wave echo reflected from the workpiece surface 14, for evaluation of the running time. The housing 44 also accommodates an evaluation circuit 54 which calculates a distance A between a common plane E of the housing openings 50, 52 and the workpiece surface 14, from the running times of the ultrasound waves. Moreover, the housing 44 in addition to the evaluating circuit 54, also includes a computing and comparing circuit 56 with a storage 70, whose operation will be described herein below.

The current supply of the device 12 with direct current of low voltage can be performed either through a battery inserted in a battery compartment of the housing 44, or alternatively through a not shown transformer accommodated in the housing 4 of the power drill. The device 12 is supplied with current through two current removing rail 42 extending in a covered manner in the undercut 38 of the guiding sleeves 40, and corresponding not shown contacts on the housing 44, as shown in FIG. 3.

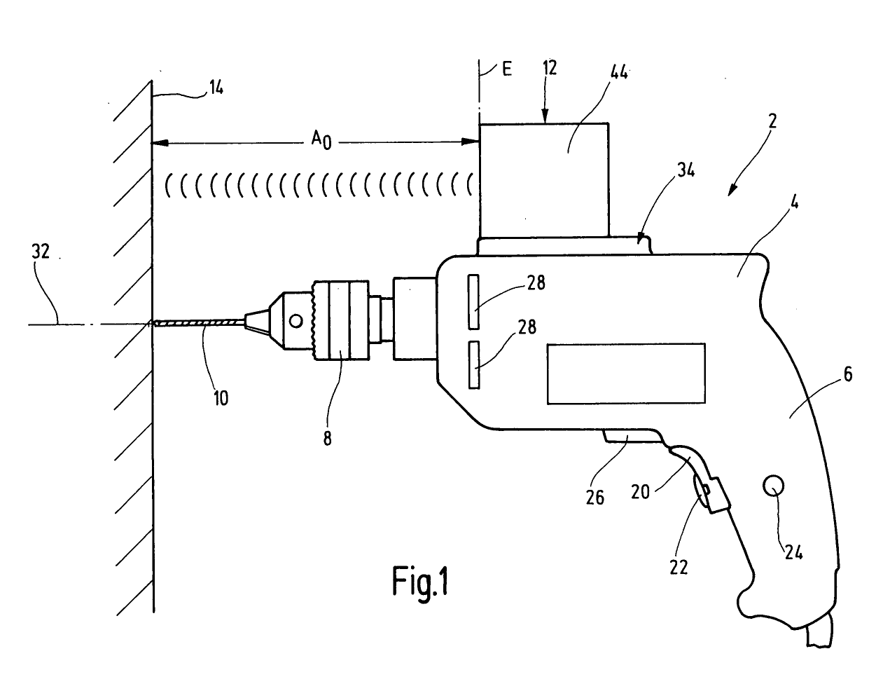

FIG. 4 shows the rear end side of the housing 44 which faces away from the workpiece surface 14. A power switch 58 and an input keyboard composed of three keys 60, 62, 64 are arranged there also. The power switch 58 turns on the device 12, to activate the transmitter 46 and the receiver 48. The second and third key 60, 62 can input the desired drill hole depth starting from zero in steps, from correspondingly one centimeter or one millimeter. The inputted or preset drill hole depth Tₑ is stored in the storage 70 of the computing and comparing circuit 56. The third key 64 serves for detection and storage of an output distance Aₒ between the plane E of the housing openings 50, 52 and the wall surface 14 in an initial condition before the drilling, when the drill 10 abuts with its tip against the wall surface 14 as shown in FIG. 1.

Alternatively, the keyboard instead of the three keys 60, 62, 64 can be provided with two keys, of which one key can have a double function. A numerical light diode display 66, which is well visible for the user during drilling, is located above the power switch 58 and the keys 60, 62, 64. A desired drill hole depth is indicated on the display 66 after each input, for controlling the set value Tₑ. When after turning on of the device 12 no drill hole depth is set on the keys 60, 62, then during the drilling on the display 66 for example the drilling progress is indicated in centimeters or millimeters. In other words, the difference between the initial distance Aₒ and an instantaneously measured distance Aₘ starting from the workpiece surface 14 is indicated on it. In the case of the presetting of a drill hole depth Tₑ, preferably the difference from this preset drill hole depth Tₑ and the drilling progress Aₒ-Aₘ is indicated.

For measuring the drilling progress Aₒ-Aₘ, after turning on of the device 12 at the power switch 56, by actuation of the key 62 the initial distance Aₒ is measured and stored in the storage 70 of the computing and comparing circuit 56. By actuating of the key 62, simultaneously a continuos activation of the transmitter 46, and the receiver 48 is released, to measure during the drilling continuously the instantaneous distance Aₘ between the plane E of the housing openings 50, 52 and the workpiece surface 14. The drilling progress Aₒ-Aₘ is continuously computed from the initial distance Aₒ stored in the storage 70 and the continuously measured instantaneous distance Aₘ, in a microcomputer 72 of the computing and comparing circuit 56. It is indicated on the display 66.

When after the turning on of the device 12 with the keys 60, 62 a desired drill hole depth Tₑ is set, then the drilling progress computed from the difference of Aₒ-Aₘ is uninterruptedly compared in the microcomputer 72 with the preset drill hole depth Tₑ, and the difference, or in other words Tₑ-(Aₒ-Eₘ) is indicated on the display 66. When the difference Tₑ-(Aₒ-Aₘ) assumes the value 0, the desired drill hole depth is reached and the display 66 with the indicator 00 is switched automatically to the blinking mode.

In addition, it can be provided that the electric motor of the power drill 2 is turned off when the prepreset drill hole depth Tₑ is reached. In this case the guide 34, in addition to the current removing rails 40, also has two control rails 74 which operate for controlling the electric motor. They are connected inside the housing 4 of the power drill 2 with not shown switch for interrupting the current circuit of the electric motor. When the preset drill hole depth Tₑ is reached, the control rails 74 are supplied with current from the computing and comparing circuit 56 and thereby the switch opens.

It will be understood that each of the elements described above, or two or more together, may also find a useful application in other types of constructions and methods differing from the types described above.

While the invention has been illustrated and described as embodied in a device for and automatic measurement of drilling depth on hand power tools, as well as hand power tool for drilling and method of drilling with drilling depth measurements, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A device for determining a reaching of a preset drill hole depth in a drill hole which is drilled by a drilling tool of a drilling apparatus from a workpiece surface in a workpiece, the device comprising a measuring means which is mountable on and dismountable from the drilling apparatus for contactless measurement of an initial distance when a tip of the drilling tool abuts against the workpiece surface; and means for computing an instantaneous distance to the workpiece surface as well as computing by a computing and comparing circuit a drilling progress from the measured initial distance and a measured instantaneous distance, and comparing the drilling progress with a preset drill hole depth.

2. A device as defined in claim 1, wherein said measuring means has an emitter and a receiver for wave signals, and an evaluation circuit for evaluation of wave signals emitted by said emitter to the workpiece surface and reflected from the workpiece surface to said receiver.

3. A device as defined in claim 1; and further comprising input means for setting a desired drill hole depth.

4. A device as defined in claim 1; and further comprising a storage for intermediately storing a parameter selected from the group consisting of the set drill hole depth and the measured initial distance.

5. A device as defined in claim 1; and further comprising indicating means for indicating a parameter selected from the group consisting of the preset drill hole depth, the drilling progress, and the reaching of the preset drilling hole depth.

6. A device as defined in claim 5, wherein said indicating means includes a plurality of light diodes.

7. A device as defined in claim 1, wherein said indicating means includes a numerical indicator.

8. A device as defined in claim 1, wherein said measuring means includes an energy source which is separate from an energy source of the drilling apparatus.

9. A device as defined in claim 1, wherein said measuring means during mounting on the drilling apparatus is connectable to an energy source of the latter.

10. A drilling apparatus, comprising a drilling tool; and a device for determining a reaching of a preset drill hole depth in a borehole which is drilled by said drilling tool from a workpiece surface in a workpiece, said device including measuring means which is mountable on and dismountable from the drilling apparatus for contactless measurement of an initial distance when a tip of the drilling tool abuts against the workpiece surface, and means for computing an instantaneous distance to the workpiece surface as well as computing by a computing and comparing circuit a drilling progress from the measured initial distance and a measured instantaneous distance, and comparing the drilling progress with a preset drill hole depth.

11. A drilling apparatus as defined in claim 10, wherein said device is removable.

12. A drilling apparatus as defined in claim 10, wherein said drilling apparatus includes a drive motor; and further comprising an interruption switch located in a current circuit of said drive motor and controlled by said computing and comparing circuit.

13. A method of drilling, comprising the steps of drilling a drill hole in a workpiece from a workpiece surface with a drilling tool of a drilling apparatus; determining a reaching of a preset drill hole depth from the workpiece surface at the working apparatus; before the drilling of the borehole measuring an initial distance at which a tip of the drilling tool abuts against the workpiece surface, and during the drilling continuously contactlessly measuring an instantaneous distance from the drilling apparatus to the workpiece surface, continuously calculating a drilling progress from the measured initial distance and the measured instantaneous distance, and comparing the calculated drilling progress with a preset drill hole depth.

14. A method as defined in claim 13; and further comprising indicating at least one parameter selected from the group consisting of the preset drill hole depth, the drilling progress and the reaching of the preset drilling hole depth on an indicator of the drilling apparatus.

15. A method as defined in claim 13; and further comprising indicating at least one parameter selected from the group consisting of the preset drill hole depth, the drilling progress and the reaching of the preset drilling hole depth on a device arranged on the drilling apparatus.

16. A method as defined in claim 13; and further comprising interrupting a current circuit of a drive motor of the drilling apparatus, upon reaching the preset drill hole depth.
